(19) United States
(12) Patent Application Publication
(10) Pub. No.: US 2021/0341923 A1
(43) Pub. Date: Nov. 4, 2021

(54) CONTROL SYSTEM FOR AUTONOMOUS DRIVING OF A VEHICLE

(71) Applicant: Knorr-Bremse Systeme Fuer Nutzfahrzeuge GmbH, Muenchen (DE)

(72) Inventors: Adam Szoellosi, Budapest (HU); Huba Nemeth, Budapest (HU); Viktor Tihanyi, Budapest (HU); Balazs Gal, Budapest (HU)

(73) Assignees: Knorr-Bremse Systeme Fuer Nutzfahrzeuge GmbH, Muenchen (DE); Knorr-Bremse Systeme Fuer Nutzfahrzeuge GmbH, Muenchen (DE)

(21) Appl. No.: 17/273,671

(22) PCT Filed: Sep. 6, 2019
(86) PCT No.: PCT/EP2019/073845

§ 371 Date: Mar. 4, 2021

(30) Foreign Application Priority Data
Sep. 18, 2018 (EP) 18195241.7

(51) Int. Cl. G05D 1/00; G05D 1/02

(52) U.S. Cl. CPC G05D 1/0094; G05D 1/0257; G05D 2201/0213; G05D 1/0246; G05D 1/0088; G05D 1/0255

(57) ABSTRACT

A control system for autonomous driving of a vehicle for enabling a safe operation of autonomously driving vehicle, includes a first environment sensor attached at a specific location of the vehicle configured to observe a specific portion of environments of the vehicle, and at least one second environment sensor attached at any specific location of the vehicle configured to observe at least a portion of the specific portion of environments of the vehicle.

### FIELD OF THE INVENTION

The present invention relates to a control system for autonomous driving of a vehicle, in particular to a control system for autonomous driving of a transport vehicle, as e.g. a truck and trailer combination.

### BACKGROUND INFORMATION

The autonomous operation of transport vehicles is a new field. Highly sophisticated functions require high-end hardware infrastructure including different type of sensors and perception technologies. Until now, SAE Automation level 2 systems require presence and attention of the driver. SAE Automation level 3 systems should manage autonomous driving without continuous attention of the driver. In this case, an incident may occur when an element of the system malfunctions or becomes offline.

Until now, in particular in the field of transport vehicle, no safe solution or consideration which is able to handle such a situation and is able to carry out minimal risk safety maneuver even after a partial malfunction has been known.

### SUMMARY OF THE INVENTION

Therefore, an object underlying the invention is to enable a more secure safe-operation of autonomously driving vehicle.

The object may be achieved by a control system as described herein.

According to an aspect of the invention, a control system for autonomous driving of a vehicle, comprises a first environment sensor attached at a specific location of the vehicle configured to observe a specific portion of environments of the vehicle, and at least one second environment sensor attached at any specific location of the vehicle configured to observe at least the same portion of the specific portion of environments of the vehicle simultaneously to an observation of the first environment sensor.

By such a configuration of the control system, wherein several sensors simultaneously observe a same portion of a specific portion of environments of the vehicle, a redundant environment sensor architecture as a part of a redundant HW architecture that can fulfil the requirement to carry out minimal risk safety manuever even after a partial malfunction is provided.

In an advantageous implementation of the control system, the first environment sensor is a radar device attached at the rear side of the vehicle such that it looks rearwards.

By using the radar device as the first environment sensor, a reliable sensor supplying an exact observation result even in darkness or under bad weather conditions is provided.

In an advantageous implementation of the control system, the second environment sensor or one of the second environment sensors is a camera device attached at the rear side of the vehicle such that it looks rearwards.

By such a configuration of the control system, an environment sensor using another physical principle is provided so that the environment sensors can be insensitive to different environmental impacts. Therefore, a damage of one of the environment sensors does not inevitably lead to a damage of a redundant environment sensor using a different physical operation principle.

In a further advantageous implementation of the control system, the first environment sensor is a camera device attached at a rear side of the vehicle such that it looks rearwards.

By using the camera device as the first environment sensor, the control system can be used for a docking maneuver and for detecting the environments while enhancing the insensitivity of the control system.

In a further advantageous implementation of the control system, the second environment sensor or one of the second environment sensors is an ultrasonic sensor device attached at the rear side of the vehicle such that it looks rearwards.

By using the ultrasonic sensor device, the control system can also be used for a docking maneuver and for detecting the environments while enhancing the insensitivity of the control system.

In another advantageous implementation of the control system, the second environment sensor or one of the second environment sensors is a Lidar device attached at the rear side of the vehicle such that it looks rearwards.

This configuration of the control system provides a long range detection of the specific portion of the environments of the vehicle.

In a further advantageous implementation of the control system, the second environment sensor or one of the second environment sensors is a wide angle camera device attached at an area of a rear corner of the vehicle and it is configured to look rearwards and laterally of the vehicle for observing the specific portion of the environments of the vehicle and a further specific portion of the environments of the vehicle.

By this configuration, not only the specific portion of the environments of the vehicle, e.g. behind the vehicle, can be observed but also a further specific portion of the environments of the vehicle, e.g. laterally of the vehicle, can be observed.

In a specific advantageous implementation of the control system, the wide angle camera device is provided with a fisheye lens.

The provision of the fisheye lens enables an easy structure of the wide angle camera device while observation of a portion of environment behind the vehicle and of a portion of environment laterally of the vehicle is possible.

In a further specific advantageous implementation of the control system, the camera device is configured to look also downwardly.

By such an arrangement, a substantially unobstructed observation of the portion of environment behind the vehicle and of a portion of environment laterally of the vehicle is easily possible.

In a further advantageous implementation, the control system further comprises a side radar device attached at a lateral side of the vehicle such that it looks laterally of the vehicle for observing the further specific portion of the environments of the vehicle and another device for observing the further specific portion of the specific environments of the vehicle.

By the radar device for observing the further specific portion of the environments of the vehicle, a reliable sensor supplying an exact observation result even in darkness or under bad weather conditions is provided.

In a further advantageous implementation, the control system further comprises a side Lidar device attached at a lateral side of the vehicle such that it looks laterally of the vehicle for observing the further specific portion of the environments of the vehicle and another device for observing the further specific portion of the environments of the vehicle.

By the Lidar device attached at a side of the vehicle, monitoring objects in close proximity at the respective side, detecting a hazardous object in close proximity with high confidence, and providing a 3 D representation of the surrounding environments are possible.

According to another aspect of the invention, a trailer attachable to an autonomous driven vehicle comprises the control system.

When the trailer is provided with the control system, the portion of environments behind the trailer and lateral of the trailer can be monitored.

According to a further aspect of the invention, a single autonomous driven vehicle comprises the control system.

In this case, the single vehicle without an attached trailer can perform a safe autonomous driving even in case of, e.g., a docking manoeuver.

According to further aspects of the invention, a system comprises a trailer comprising the control system and a single autonomous driven vehicle provided with the control system or without the control system.

By these configurations, in any case, the safe autonomous driving of the system is possible even in case of, e.g., a docking manoeuver.

In the following, the invention is elucidated in detail by an embodiment referring to the attached drawing.

### BRIEF DESCRIPTION OF THE DRAWING

FIG. 1 shows a vehicle including a control system according to the invention.

### DETAILED DESCRIPTION

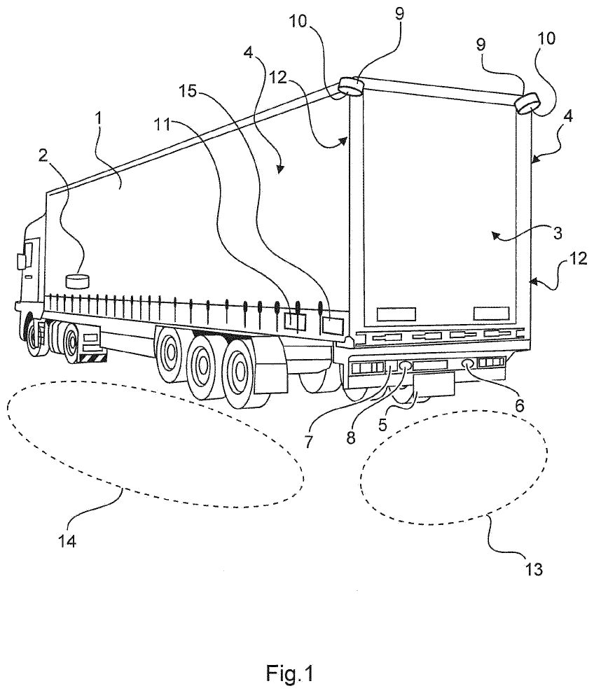

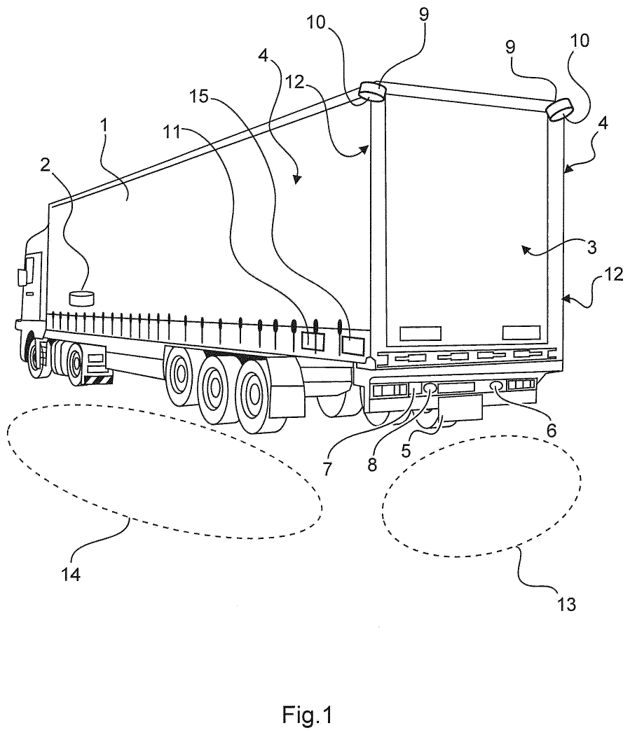

FIG. 1 shows a vehicle 1 including a control system 2 for autonomous driving of the vehicle 1. The vehicle 1 is trailer, wherein the trailer has a rear side 3 and two lateral sides 4. Alternative, the vehicle 1 can also be provided in another configuration, e.g. a single autonomous driven vehicle, or a system comprising a trailer including the control system 2 and a single autonomous driven vehicle either comprising the control system 2 or without the control system 2.

The control system 2 comprises a first environment sensor attached at any specific location of the vehicle configured to observe a specific portion of environments 13 of the vehicle, and one second environment sensor or several second environment sensors attached at any specific location of the vehicle configured to observe at least a portion of the specific portion of environments 13 of the vehicle 1 simultaneously to an observation of the first environment sensor.

In particular, the first environment sensor is a radar device 5 attached at the rear side 3 of the vehicle 1 such that it looks rearwards for observing the specific portion of environments 13 of the vehicle 1, wherein the specific portion of environments 13 of the vehicle 1 is located behind the vehicle 1.

Alternatively, the first environment sensor can be a camera device 6 attached at the rear side 3 of the vehicle 1 such that it looks rearwards. In an alternative embodiment, the first environment sensor can be a sensor functioning on another physical principle.

In this embodiment, one of the second environment sensors is the camera device 6 attached at the rear side 3 of the vehicle 1 such that it looks rearwards.

Furthermore, one of the second environment sensors is an ultrasonic sensor device 7 attached at the rear side 3 of the vehicle 1 such that it looks rearwards and another one of the second environment sensors is a Lidar device 8 attached at the rear side 3 of the vehicle 1 such that it looks rearwards.

A further one of the second environment sensors is formed by two wide angle camera devices 9 attached at a rear corner 12 of the vehicle 1 and being configured to look rearwards and laterally of the vehicle 1 for observing the specific portion of the environments 13 of the vehicle 1 and a further specific portion of the environments 14 of the vehicle 1, wherein the further specific portion of the environments 14 of the vehicle 1 is located laterally from the vehicle 1. The wide angle camera devices 9 are respectively provided with a fisheye lens 10. Furthermore, the wide angle camera devices 9 are attached in an area of a rear corner of the vehicle 1 such that they are configured, except from looking rearwards and laterally of the vehicle 1, to look also downwardly. In alternative embodiments, only one wide angle camera device 9 or wide angle camera devices 9 in a suitable number and camera devices having another suitable lens than a fisheye lens 10 are provided. Moreover, alternatively, the wide angle camera devices 9 are not attached at a rear corner 12 of the vehicle 1, but at another location where an area behind and sideward of the vehicle can be seen.

At a lateral side of the vehicle 1, a side radar device 11 is attached such that it looks laterally of the vehicle 1 for observing the further specific portion of the environments 14 of the vehicle 1 and the control system 1 comprises the fisheye lens camera device 9 as another device for observing the further specific portion of the environments 14 of the vehicle 1. Furthermore a side Lidar device is attached such that it looks laterally of the vehicle 1 for observing the further specific portion of the environments 14 of the vehicle 1.

In alternative embodiments, not all of the sensors of this embodiment are provided, but, depending on the requested functionality, appropriate ones of the sensors are provided.

In use, the environment sensors respectively observe one of the respective portions of the environments 13, 14. One portion of the environments 13 is observed by several environment sensors. In the case that one of the sensors is damaged or does not work due to another reason, the portion of the environments is still observed by at least one other environment sensor. The malfunction of the environment sensor is stored in a system in order to readout later and/or it is displayed to a driver of the vehicle.

Although the present invention has been described with reference to specific features and embodiments thereof, it is evident that various modifications and combinations can be made thereto without departing from the spirit and scope of the invention. The specification and drawings are, accordingly, to be regarded simply as an illustration of the invention as defined by the appended claims, and are contemplated to cover any and all modifications, variations combinations or equivalents that fall within the scope of the present invention.

### THE REFERENCE SIGN LIST IS AS FOLLOWS

1 vehicle
2 control system
3 rear side
4 lateral side
5 radar device
6 camera device
7 ultrasonic sensor device
8 Lidar device
9 wide angle camera device
10 fisheye lens
11 side radar device
12 rear corner
13 specific portion of environments
14 further specific portion of environments
15 side Lidar device

1-15. (canceled)

16. A control system for autonomous driving of a vehicle, comprising:
a first environment sensor attached at a specific location of the vehicle configured to observe a specific portion of environments of the vehicle; and
at least one second environment sensor attached at any specific location of the vehicle being configured to observe at least a portion of the specific portion of environments of the vehicle simultaneously to an observation of the first environment sensor.

17. The control system of claim 16, wherein the first environment sensor includes a radar device attached at a rear side of the vehicle such that it looks rearwards.

18. The control system of claim 17, wherein the second environment sensor or one of the second environment sensors includes a camera device attached at the rear side of the vehicle (1) such that it looks rearwards.

19. The control system of claim 16, wherein the first environment sensor includes a camera device attached at a rear side of the vehicle such that it looks rearwards.

20. The control system of claim 16, wherein the second environment sensor or one of the second environment sensors includes an ultrasonic sensor device attached at the rear side of the vehicle such that it looks rearwards.

21. The control system of claim 16, wherein the second environment sensor or one of the second environment sensors includes a Lidar device attached at the rear side of the vehicle such that it looks rearwards.

22. The control system of claim 16, wherein the second environment sensor or one of the second environment sensors includes a wide angle camera device attached at an area of a rear corner of the vehicle and is configured to look rearwards and laterally of the vehicle for observing the specific portion of the environments of the vehicle and a further specific portion of the environments of the vehicle.

23. The control system of claim 22, wherein the wide angle camera device includes a fisheye lens.

24. The control system of claim 22, wherein the wide angle camera device is configured to look also downwardly.

25. The control system of claim 16, further comprising:
a side radar device attached at a lateral side of the vehicle such that it looks laterally of the vehicle for observing a further specific portion of the environments of the vehicle and another device for observing the further specific portion of the environments of the vehicle.

26. The control system of claim 16, further comprising:
a side Lidar device attached at a lateral side of the vehicle such that it looks laterally of the vehicle for observing a further specific portion of the environments of the vehicle and another device for observing the further specific portion of the environments of the vehicle.

27. A trailer attachable to an autonomous driven vehicle, comprising:
a control system for the autonomous driving of the vehicle, including:
a first environment sensor attached at a specific location of the vehicle configured to observe a specific portion of environments of the vehicle; and
at least one second environment sensor attached at any specific location of the vehicle being configured to observe at least a portion of the specific portion of environments of the vehicle simultaneously to an observation of the first environment sensor.

28. A single autonomously driven vehicle, comprising:
a control system for autonomous driving of the vehicle, including:
a first environment sensor attached at a specific location of the vehicle configured to observe a specific portion of environments of the vehicle; and
at least one second environment sensor attached at any specific location of the vehicle being configured to observe at least a portion of the specific portion of environments of the vehicle simultaneously to an observation of the first environment sensor.

29. A system, comprising:
a trailer; and
a single autonomous driven vehicle;
wherein at least one of the trailer and the vehicle includes:
a control system for the autonomous driving of the vehicle, including:
a first environment sensor attached at a specific location of the vehicle configured to observe a specific portion of environments of the vehicle; and
at least one second environment sensor attached at any specific location of the vehicle being configured to observe at least a portion of the specific portion of environments of the vehicle simultaneously to an observation of the first environment sensor.

30. The system of claim 29, wherein the single autonomous driven vehicle includes:
the control system for the autonomous driving of the vehicle, including:
the first environment sensor attached at the specific location of the vehicle configured to observe the specific portion of environments of the vehicle; and
the at least one second environment sensor attached at any specific location of the vehicle being configured to observe at least the portion of the specific portion of environments of the vehicle simultaneously to an observation of the first environment sensor.
